(19) United States
(12) Patent Application Publication
(10) Pub. No.: US 2013/0213675 A1
(43) Pub. Date: Aug. 22, 2013

(54) SELF SERVICING FIRE EXTINGUISHER WITH INTERNAL MIXING AND EXTERNAL CO2 CHAMBER

(71) Applicants: Randy ROUSSEAU, Riverside, CA (US); Hector ROUSSEAU, Riverside, CA (US)

(72) Inventors: Randy ROUSSEAU, Riverside, CA (US); Hector ROUSSEAU, Riverside, CA (US)

(21) Appl. No.: 13/401,723

(22) Filed: Feb. 21, 2012

(51) Int. Cl. A62C 13/62

(52) U.S. Cl. 169/71

(57) ABSTRACT

Improvements to a portable media delivery system are disclosed. The improvements allow for frequent and simpler untrained and automatic self-servicing of a media delivery system. The improvements include an anti-bridging mechanism that fluffs, mixes or stirs the powder within the chamber to keep it in a liquefied state. Additional improvements include a larger opening to more quickly fill and inspect the powder within the chamber. Another improvement includes the use of a gas or CO₂ canister located external to the chamber or reservoir to allow easier servicing or replacement of just the CO₂ canister as well as the ability to maintain the chamber in an un-pressurized condition, allows for non-HASMAT shipping. These features will extend the service intervals while maintaining the media delivery system in a ready condition.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a media delivery system. More particularly, the present invention relates to a fire extinguisher, crowd control, fertilizer, insecticide or similar delivery system that uses an external pressurized canister where the ratio of the gas in the pressure cartridge to the media provides proper application of the media within a reservoir. The ability to quickly change the external pressure canister further provides additional benefit to quickly reuse the media delivery system.

2. Description of Related Art Including Information Disclosed Under 37 CFR 1.97 and 1.98

Most portable fire extinguishers or media delivery systems are of a similar design where the media is contained in a pre-pressurized chamber. Devices of this type require scheduled maintenance because the media within the chamber can settle and cake, preventing it from being dispensed when needed. The pressure within the chamber may also leak over time and be insufficient to propel the media out of the reservoir. A further limitation, based upon this design is due to the pressurized condition of the reservoir where powder or media is placed into the reservoir in a small opening in the top. To properly expend the fire retardant and or media, a ratio of the housing volume, gas type, gas volume and the amount of media is important.

Current extinguishers or media delivery systems are open to wear and tear because of the constant pressure and tear down process. When serviced they are fired into a recycling chamber and all the parts must be disassembled and cleaned. All the pressure rings must be replaced and every part must them be re-assembled with new powder being placed within the chamber prior to pressurizing the chamber. The servicing of current fire extinguishers and pressurized media delivery systems often creates significant wear and tear.

U.S. Pat. No. 6,189,624 issued to James on Feb. 20, 2001 and Japan Patent Number JP 9,225,056 issued to Yamazaki Tomoki on Sep. 2, 1997 discloses fire extinguishing mechanisms where the chamber is not continuously pressurized, and the pressurized chamber is a separate entity integrated within the chamber. While these patents disclose a separate pressurized canister, the canister is not located in a position that is easy to service, replace, or inspect. This minimizes the ability determine the charge level of the CO₂ cartridge.

U.S. Pat. No. 2,541,554 issued to C H Smith on Feb. 13, 1951 and Russian Patent Number RU 2,209,101 issued to Glavatski G. D. Et Al. Nov. 2, 2002 discloses a fire extinguisher with external CO₂ gas cartridge. In the case US '554 the CO₂ gas cartridge sits on top of the fire extinguisher chamber and is not integrated within the handle of the fire extinguisher. In the case of RU '101 the CO₂ gas cartridge is external to the extinguisher and is connected to the extinguisher with a pipe or hose. While both of these patents disclose a CO₂ cartridge that is external to the chamber, neither of them is placed in the handle to allow a configuration of the fire extinguisher that is simple to inspect and replace.

Due to the pressurized condition that exists with pressurized fire extinguishers, the opening where powder is placed into the extinguisher is limited due to the structural requirement to maintain pressure within the chamber at all times. The proposed application eliminates this need by providing an external CO₂ gas cartridge, thus allowing the chamber to exist in a normally un-pressurized condition. Because the chamber is not under pressure the top opening of the extinguisher can be enlarged to allow easier filling of the fire extinguisher with powder, or checking the amount and or condition of the powder within the chamber.

What is needed is a media delivery system with a pressurized external cartridge where the pressurized cartridge is located in the handle, a fluffer is accessible from outside the media reservoir, and the media reservoir has an enlarged top opening for filling the reservoir. The proposed media delivery system provides this solution by providing a media delivery system with an external pressure cartridge, and identifies optimal ratios of a quickly exchangeable external cartridge.

### BRIEF SUMMARY OF THE INVENTION

It is an object of the media delivery system using an external pressure cartridge to eliminate the need for service personnel to enter secure areas. The extinguisher or delivery system can have a higher level of service. Can be operated automatically “self-service” and or manually serviced by the owner or end user. This eliminates the need for non-employees to enter the privacy of business and government areas. This extinguisher or delivery system can be operated, maintained, refilled and charged with no special training or equipment allowing for anyone who purchases it to have it function like any of the office equipment that is available today like a copier, printer or water cooler. The proposed fire extinguisher and or media delivery system is not required to be broken down when it has been fired.

The reduced outside servicing and maintenance of the fire extinguisher or media delivery system is ideal for placement in secure areas. This will reduce or eliminate the possibility that a terrorist could utilize the fire extinguisher or media delivery system as a weapon, or use false identity as a service person to gain access to a secure area.

It is an object of the fire extinguisher or media delivery system to provide the media delivery from the reservoir with an external pressure canister or canister. The external canister allows the chamber to exist at or near ambient pressure that reduces the need to utilize a high strength chamber. The standard CO₂ cartridge that is used in other applications can be easily adapted to operate with the media delivery system. Since the pressure filled or CO₂ cartridge is external to the chamber or reservoir it can be easily replaced or swapped without replacing the entire unit or reservoir. This provides a tremendous benefit when a large number of devices need to be service at one time. The replaceable pressure filled or CO₂ cartridge can also be supplied with a replaceable seal rupturing device that ensures the rupturing device is sharp with each replaceable pressure or CO₂ cartridge. The ratio of the amount of gas to the volume of the reservoir and the media within the reservoir is important for proper operation.

It is another object of the media delivery system to provide media within the reservoir to be externally accessible with a fluffing mechanism. The externally accessible fluffing mechanism promotes anti-bridging of the powder within the chamber or reservoir to keep it fluffed, agitated, stirred or disturbed to prevent caking of the powder and keep the powder in a liquefied state so it is easier to spray or disperse the media. The fluffing is accomplished with paddles, flapper, chains rods or other mixing mechanisms located within the chamber or reservoir.

It is an object of the media delivery system to provide a media delivery system that can be quickly opened and closed using a variety of quick opening and closing mechanisms. Often the fire extinguishing or other media can embed in the threads of the head and make unscrewing difficult. Sliding, locking, bayonet and other forms of securing the top to the bottom housing minimize or eliminate this problem.

It is an object of the media delivery system to provide a media delivery system and where the external pressure or gas canister can be quickly exchanged using a variety of quick removal and replacement mechanisms. The need to quickly replace the gas canister allows for a reduced time to re-use the device to continue to fight a fire, dispense media or provide crowd control. Sliding, locking, bayonet and other forms of securing the gas canister minimize or eliminate this problem.

It is still another object of the media delivery system to provide a media delivery system with an enlarged filling opening. The enlarged filling opening makes it easier and faster to fill and or empty the chamber. The top can also be easily removed to visually inspect the condition of the media within the chamber.

It is still another object of the media delivery system to provide a media delivery system to be made from plastic with tapered side walls. The tapered side walls allow the media to loosen when the reservoir is inverted thereby allowing the media to expand into the tapered portion of the reservoir. The tapered sides and or the ends of the reservoir may further have fingers or other features that break-up the media when the reservoir is rotated or inverted.

It is still another object of the media delivery system to provide have a quick opening and closing top housing thereby allowing a user to quickly open and refill the reservoir. This also allows an operator to load the desired media based upon the type desired media that is being delivered.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an isometric view of a preferred embodiment of the improved media delivery system.

FIG. 2 shows a side sectional view of the media delivery system with tapered sides showing the media within the chamber.

FIG. 3 shows a side sectional view of an inverted media delivery system with tapered sides showing the media within the chamber.

FIGS. 4A-4C show movement of the media within the tapered walls of the chamber or reservoir as the chamber or reservoir is rotated.

FIG. 5 shows a second preferred embodiment of a securing mechanism of the top to the chamber.

FIG. 6 shows a third preferred embodiment of a securing mechanism of the top to the chamber or reservoir.

FIG. 7 shows the third preferred embodiment of a securing mechanism of the top to the chamber or reservoir with the top removed.

FIG. 8 shows a fourth preferred embodiment of a securing mechanism of the top to the chamber or reservoir.

FIGS. 9A and 9B shows detailed views of the embodiment shown in FIG. 13.

FIG. 10 shows a fourth preferred embodiment of a securing mechanism of the top to the chamber or reservoir.

FIGS. 11A and 11B shows detailed views of the embodiment shown in FIG. 15.

FIG. 12 shows a fourth preferred embodiment of a securing mechanism of the top to the chamber or reservoir.

FIGS. 13A and 13B shows detailed views of the embodiment shown in FIG. 17.

FIG. 14 shows a second preferred embodiment of the connection of the pressurized gas canister and the media delivery system.

FIG. 15 shows a third preferred embodiment of the connection of the pressurized gas canister and the media delivery system.

FIG. 16 shows a fourth preferred embodiment of the connection of the pressurized gas canister.

FIG. 17 shows a fifth preferred embodiment of the connection of the pressurized gas canister.

FIG. 18 shows a quick connection for the pressurized gas canister installed in the handle of media delivery system.

FIG. 19 shows a quick connection with ears on the pressurized gas canister.

FIG. 20 shows a side sectional view of the preferred embodiment of the media delivery system shown in FIG. 1.

FIG. 21 shows a re-filling operation that allows a spent unit to be re-filled or re-charged.

### DETAILED DESCRIPTION OF THE INVENTION

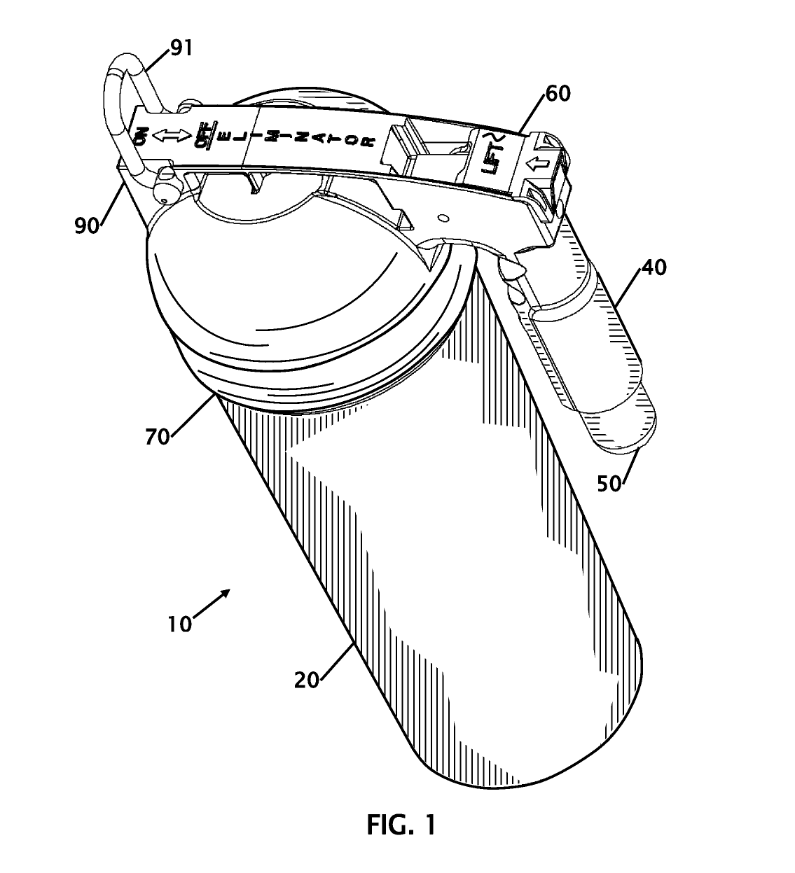

FIG. 1 shows an isometric view of a preferred embodiment of the improved media delivery system 10. The chamber 20 is substantially a cylindrical shape with a bottom and a top. In the preferred embodiment the chamber or reservoir is made from a lightweight resilient material such as plastic, but the chamber or reservoir could also be made of steel, brass, copper or aluminum. On the top of the chamber or reservoir of the media delivery system dispensing apparatus is provided. The plastic is a polymeric material that is capable of being shaped or molded, with or without the application of heat. Usually plastics are a homo-polymer or co-polymer that of high molecular weight. Plastics fitting this definition include, but are not limited to, poly-olefins, polyesters, nylon, vinyl, acrylic, polycarbonates, polystyrene, polyurethane, thermoset, polymeric and thermoplastic.

The top is screwed onto the chamber, but it could also be attached with a bayonet or latching mechanism. The lid fits on top of an enlarged opening 70 on the chamber or reservoir to allow easier filling of the chamber 20 with fire retardant or other media. The chamber 20 can be transparent or semi-transparent to provide viewing of the material within the chamber 20 to visually verify the condition of the media within the chamber 20. A wall hanging mechanism can be incorporated into the top or the head of the media delivery system to allow a device to wrap around the body of the cylinder or fork the top of the media delivery system. A handle 40 allows the operator to hold the media delivery system in an upright orientation when it is being used. The media delivery system can also be stored and or transported in the upright orientation, but the upright orientation is not critical for the storage or operation of the media delivery system. Within the handle 40 a pressurized gas canister 50 is located. While in the preferred embodiment the pressurized canister is shown within the handle other locations such as within the top of the media delivery system or adjacent to the hose are contemplated.

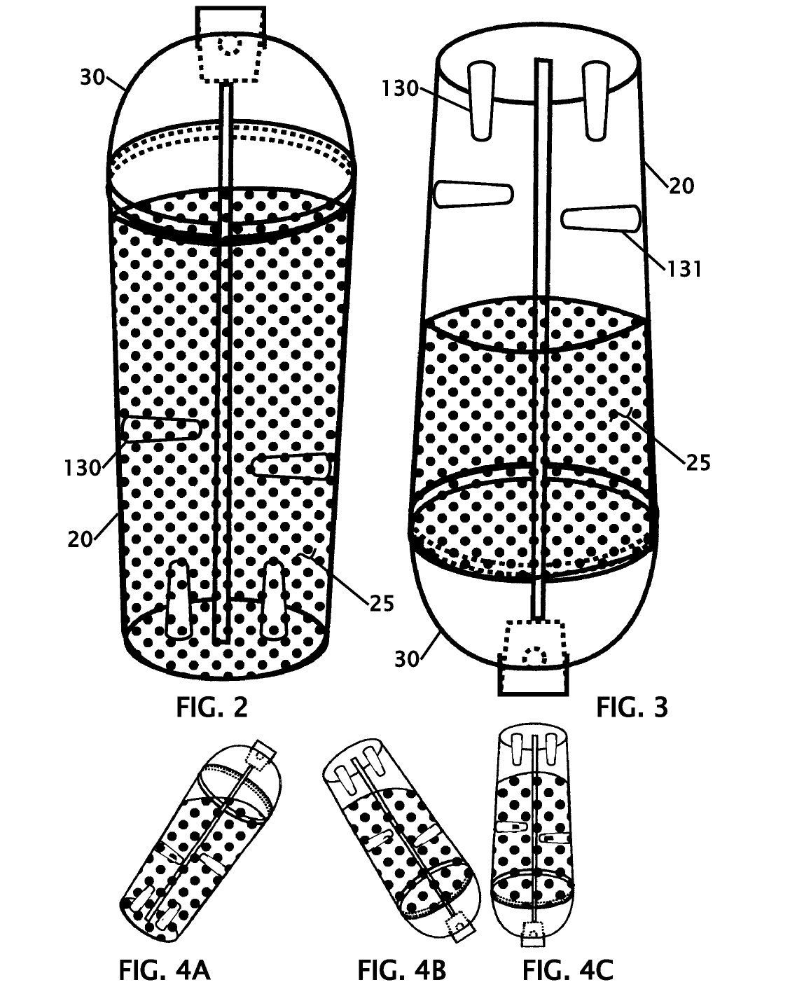

The canister 50 consists essentially of a compressed gas cartridge, but canisters of different types of gas are possible that do not promote spreading of the fire when the media delivery system is used as a fire extinguisher. Because the gas within the canister is under high pressure or in a liquid state, a small canister of gas is required to expel the contents of the chamber 20. It is also contemplated that multiple gas canisters can be placed within the handle to accommodate delivery of larger amounts of media without deviating from the inventive nature of the design. Gas canisters are available from a variety of sources and can be replaced or serviced without the need to service the entire fire extinguisher. The handle 40 provides some protection to the canister in the event the media delivery system is dropped or roughly handled. A trigger mechanism 60 opens the gas canister to pressurize the chamber and expel the media into and out of the exit port or application nozzle 90. A control valve 91 opens and closes the exit port to prevent media from pouring out of the device when the trigger 60 is no longer being depressed. The path from the gas canister 50 to the application nozzle 90 is best shown and described in FIG. 2.

FIG. 2 shows a side sectional view of the media delivery system with tapered sides showing the media or fire extinguishing powder within the chamber. FIG. 3 shows a side sectional view of an inverted media delivery system with tapered sides showing the media or fire extinguishing powder within the chamber or reservoir and FIGS. 4A-4C show movement of the media within the tapered walls of the chamber as the chamber or reservoir is rotated. The tapered side walls 20 allows the media 25 to loose when the media delivery system is inverted thereby allowing the media to expand into the tapered portion of the chamber or reservoir. The tapered sides and or the ends of the chamber or reservoir may further have finger or blades 130, 131 or other features that break-up the media when the device is rotated or inverted as shown in FIGS. 4A, 4B and 4C.

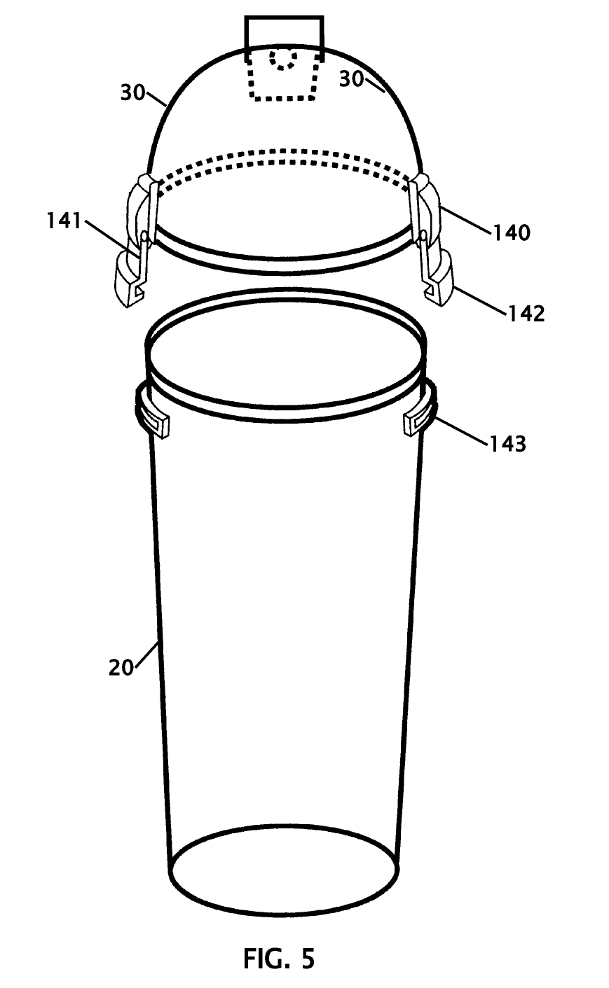

FIG. 5 shows a second preferred embodiment of a securing mechanism of the top to the chamber. The securing mechanism has ears 143 that exist on the lower chamber 20. The top housing 30 has an anchor 140 with a hasp 142 having an engaging strap 141 that engages in the ears 143. When the hasp 142 is engaged in the ears 143, the straps are pulled to lock the top housing 30 onto the chamber 20. While the figure shows two locking hasps it is contemplated that more than two can be utilized. The securing mechanism is shown connecting the top and bottom housings together, but the securing mechanism also applied to connection of the compressed gas cartridge and or a rupture pin that operates with the compress gas cartridge.

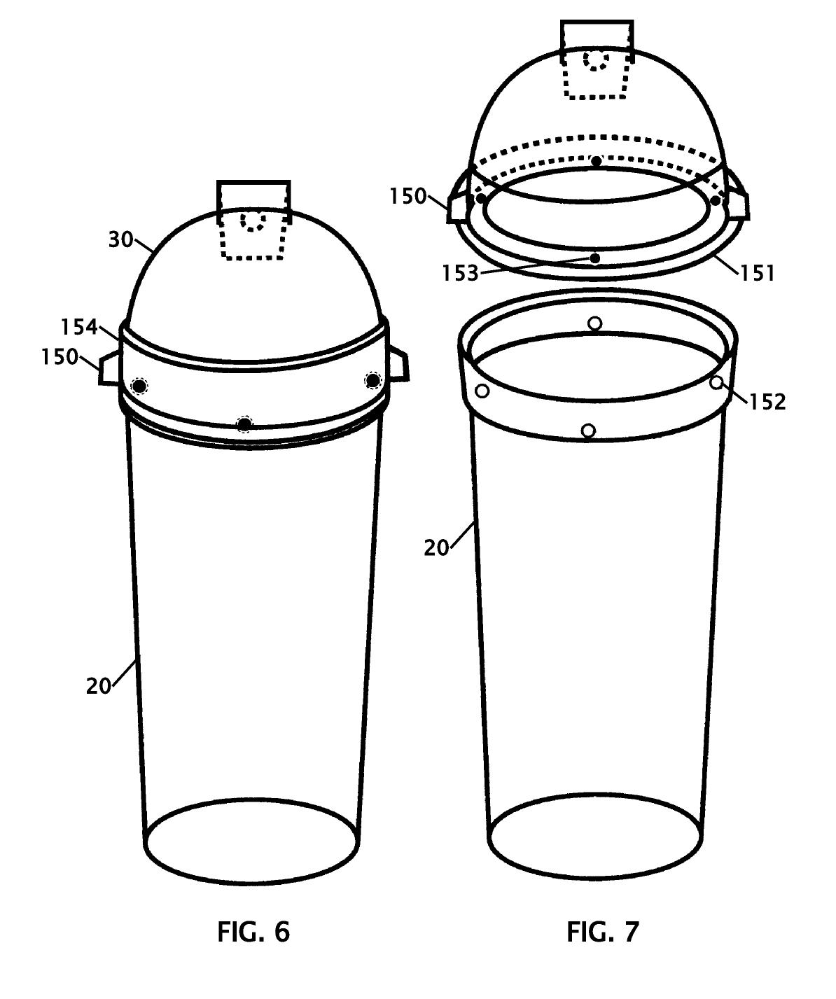

FIG. 6 shows a third preferred embodiment of a securing mechanism of the top to the chamber and FIG. 7 shows the third preferred embodiment of a securing mechanism of the top to the chamber with the top removed. This embodiment uses a series of ball bearings 153 that lock into a series of holes 152. A ring 154 is rotated or lifted with ears 150 or by manual manipulation to unlock the ball bearings 153 from the holes 152. A lip 151 seats and seals the top 20 to the bottom 30 housing.

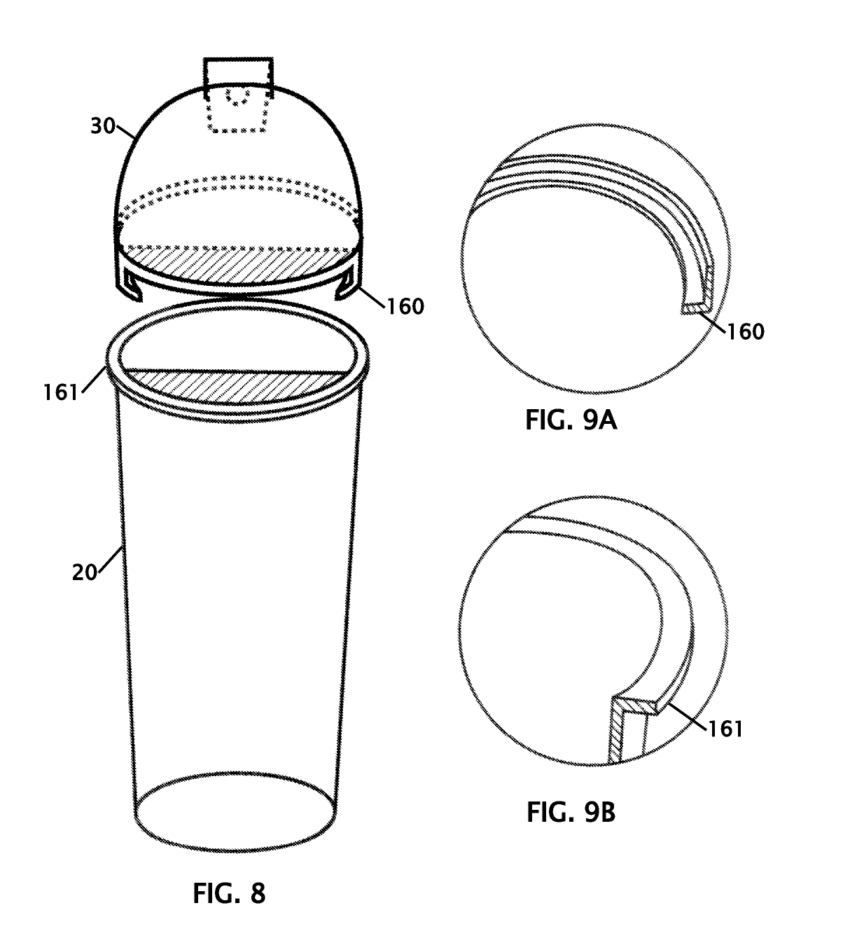

FIG. 8 shows a fourth preferred embodiment of a securing mechanism of the top to the chamber and FIGS. 9A and 9B shows detailed views of the embodiment shown in FIG. 8. In this embodiment the top housing 30 slides across the bottom housing 20. The top housing 30 has opposing lips 160 that engage onto a ridge 161 in the lower housing to lock the top housing 30 onto the bottom housing 20 when they are slid horizontally together.

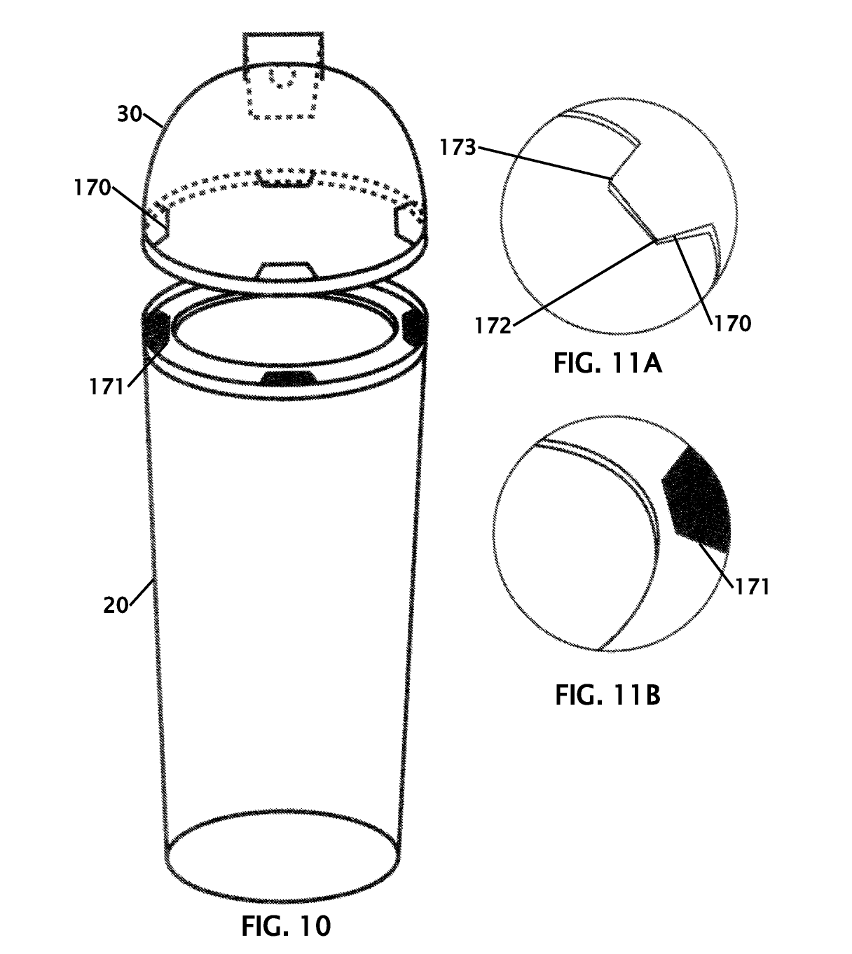

FIG. 10 shows a fourth preferred embodiment of a securing mechanism of the top to the chamber and FIGS. 11A and 11B shows detailed views of the embodiment shown in FIG. 10. In this embodiment the top housing 30 has a tab 170 where each tab 170 has a tapered front edge 172 with a wider back edge 173. The tab 170 drops into mating holes 171 located in the bottom housing 20. The tapered tab 170 pulls the top housing 30 down into the bottom housing 20.

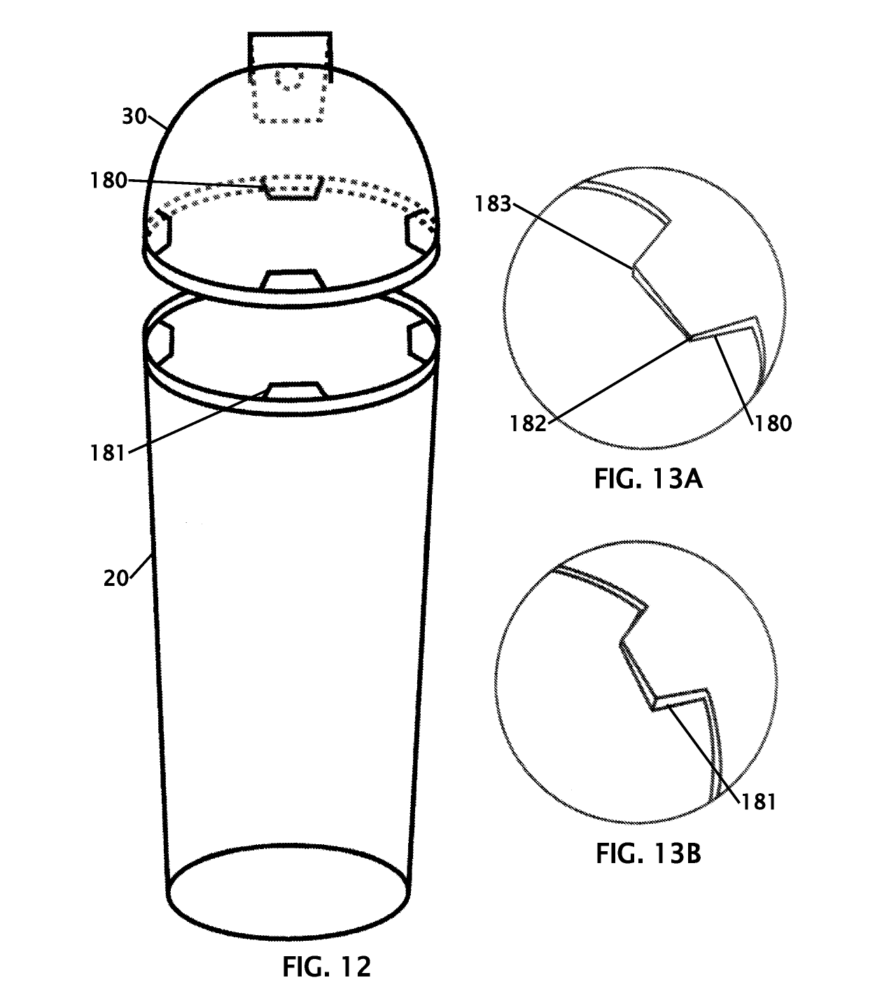

FIG. 12 shows a fourth preferred embodiment of a securing mechanism of the top to the chamber or reservoir and FIGS. 13A and 13B shows detailed views of the embodiment shown in FIG. 12. In this embodiment the top housing 30 has a tab 180 where each tab 180 has a tapered front edge 182 with a wider back edge 183. The tab 180 engage with mating tabs 181 located in the bottom housing 20. The mating tabs 181 located in the bottom housing also are tapered. The tapered tab 180 pulls the top housing 30 down into the bottom housing 20.

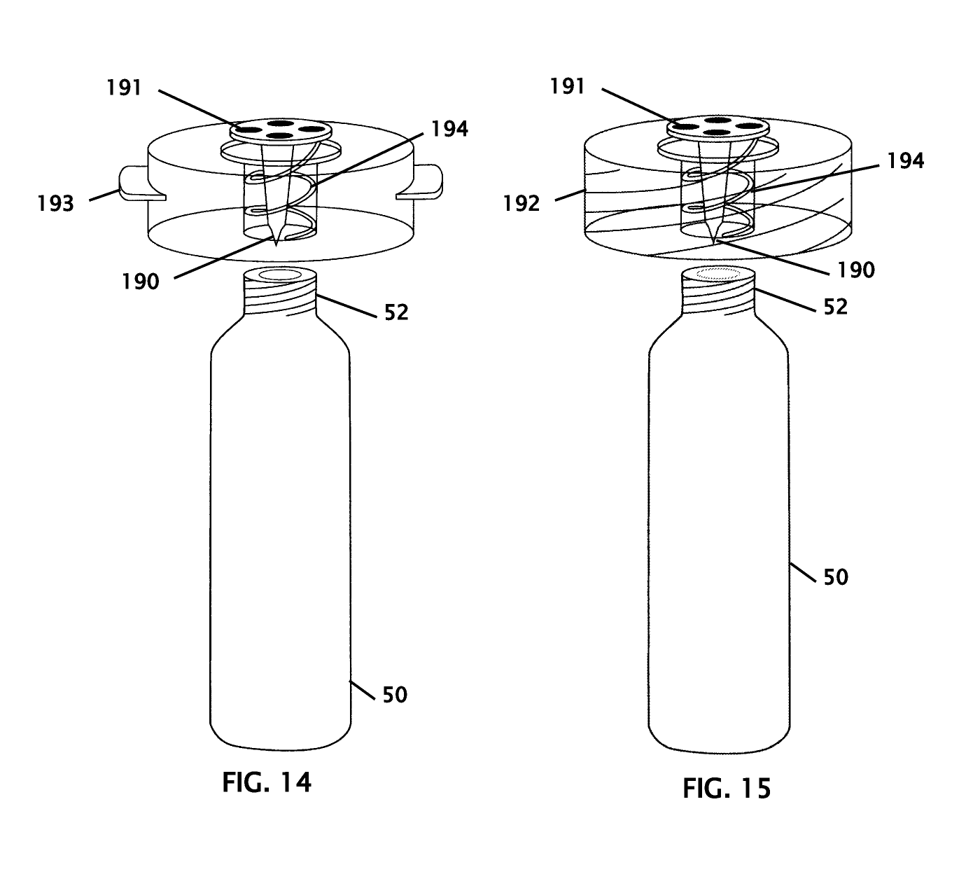

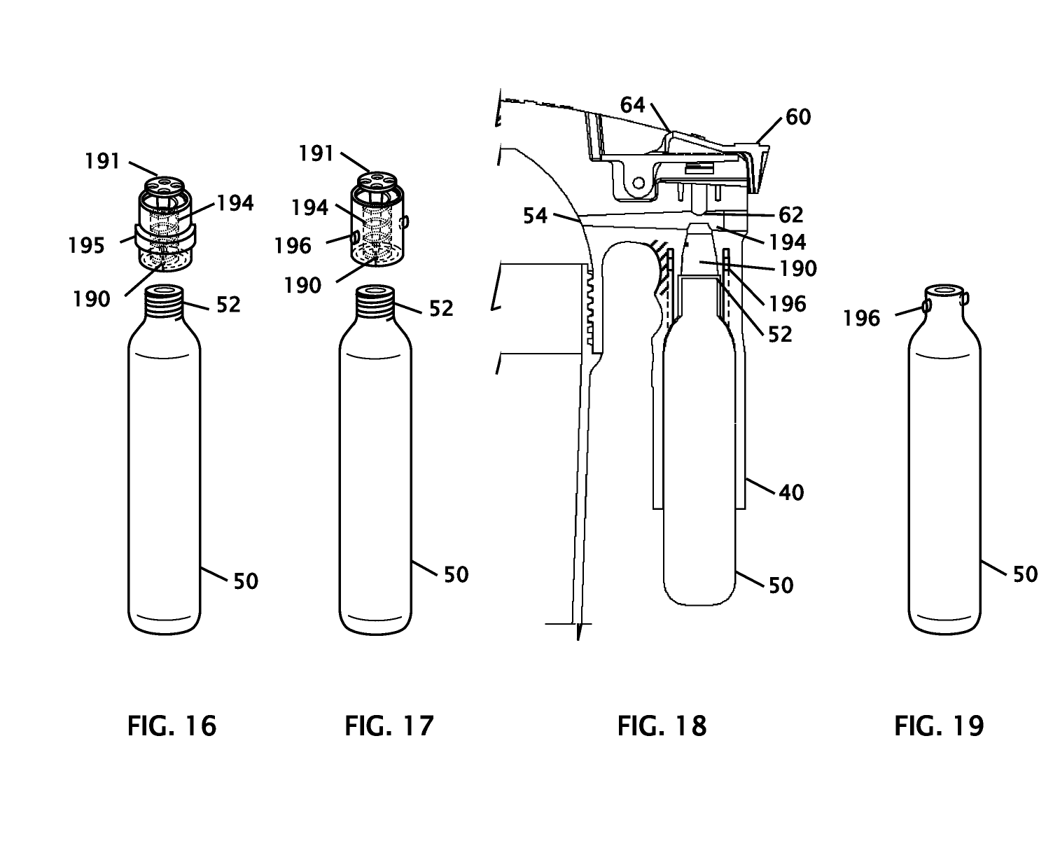

FIG. 14 shows a second preferred embodiment of the connection of the pressurized gas canister and the housing, FIG. 15 shows a third preferred embodiment of the connection of the pressurized gas canister and the housing, FIG. 16 shows a fourth preferred embodiment of the connection of the pressurized gas canister and FIG. 17 shows a fifth preferred embodiment of the connection of the pressurized gas canister. In these figures the replaceable pressure, gas or CO₂ cartridge 50 is supplied with a replaceable seal rupturing device that ensures the rupturing device is sharp with each replaceable CO₂ cartridge 50. The replaceable seal rupturing device is secured to the top of the replaceable CO₂ cartridge 50 using threads 52 or other mechanism that secures the replaceable CO₂ cartridge 50 to the replaceable seal rupturing device.

The replaceable seal rupturing device has a pin 190 that ruptures the seal on the replaceable CO₂ cartridge 50. In the preferred embodiment the pin is hollow to allow the pressurized gas to pass through the pin 190. The opposing side of the pin 190 has a plurality of vent holes 191 that allows the gas within the cartridge to vent into the fire extinguisher. A spring 194 keeps the point of the pin 190 away from the seal and also lifts the pin 190 out of the hole that is made when the cartridge is ruptured.

The seal rupturing device is secured into the media dispending device with threads 192 as shown in FIG. 15, with engaging ears 193 as shown in FIG. 14 or by other means that holds the replaceable CO₂ cartridge 50 within the fire extinguisher. In FIG. 16, an ear 195 allows the cartridge 50 to be slid horizontally into the handle of the media delivery device. In FIG. 17 the cartridge 50 has ears 196 that allow the cartridge 50 with the rupture pin 190 to be collectively inserted into the handle of the media dispensing device. This configuration is shown installed in FIG. 18.

FIG. 18 shows a quick connection for the pressurized gas canister installed in the handle of media delivery system. The pressurized canister is threaded into a fitting 52 within the handle 40 of the media delivery system. The fitting can be of a variety of types that allows engagement of the canister to the media delivery system allowing the gas to be exhausted from the canister into the body of the media delivery system. A trigger 60 or other activation mechanism controls a valve 62 to regulate the flow of the gas from the canister 50 through tube 54 and into the chamber or reservoir. The end of the inlet tube 54 blows gas into the cylinder such that it creates a swirl of the media. The head (delivery system) has an emission port and an entry port plus a pick-up tube. It has a safety guard 64 over the charging pin and a lever 60 to fire the powder through the emission port.

The powering cartridge 50 is easily installed in the handle 40 attached to the head of the device. Various safety pins, locks, tabs or other devices can be incorporated to reduce or prevent the possibility of accidental activation of the trigger. The cartridge 50 has ears 196 that allow the cartridge 50 with the rupture pin 190 that is held back by a sprint 194 and is collectively inserted into the handle of the media dispensing device. While in these embodiments the gas cartridge 50 uses a quick disconnect mechanism from the rupture pin assembly, it is also contemplated that the quick disconnect for the gas cartridge, such as the ears 196, can be incorporated into the gas cartridge 50 as shown in FIG. 19.

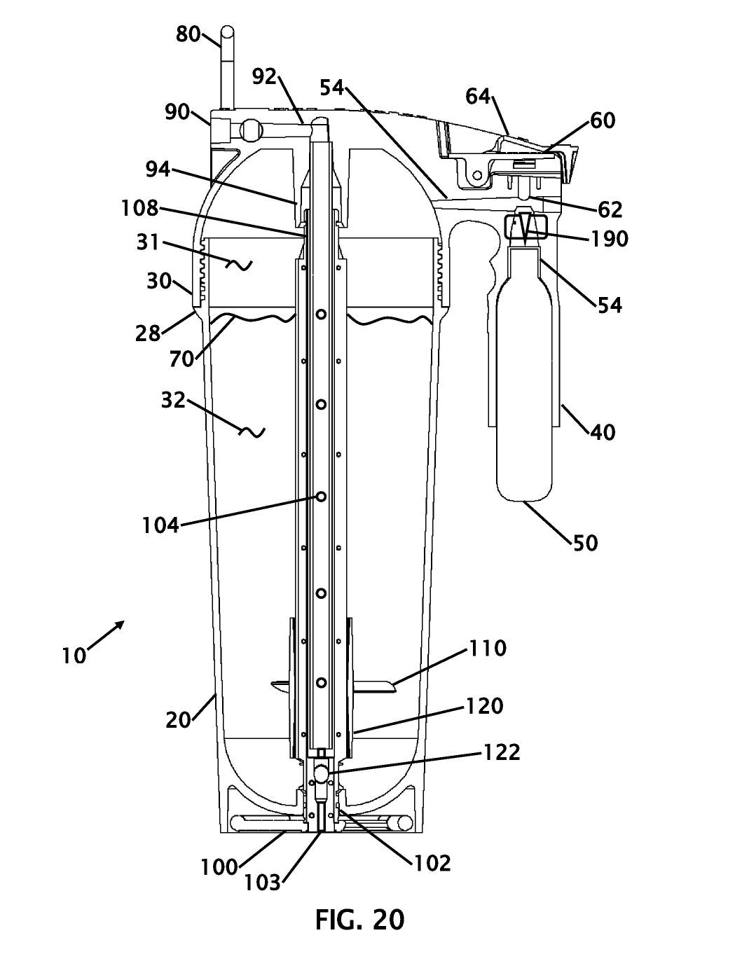

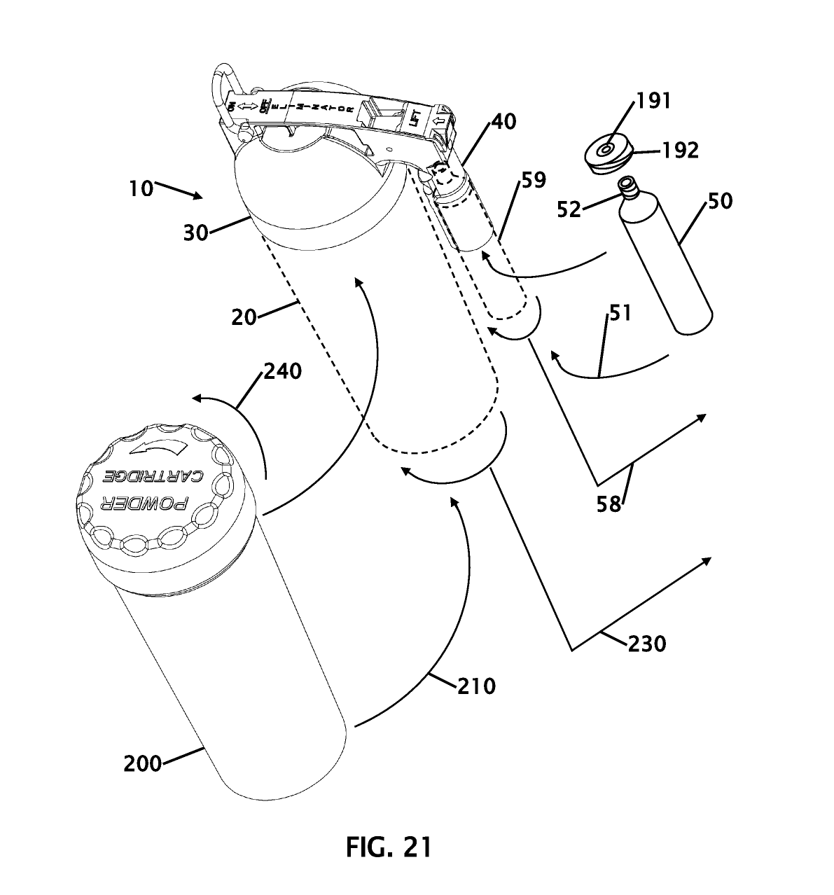

FIG. 20 shows a side sectional view of the preferred embodiment of the fire extinguisher 10 shown in FIG. 1. The plastic cylindrical chamber is fabricated with a molding or similar process and has a wall thickness of between 0.080 and 0.400 inches thick. A thickness less than 0.08 inches is too thin to retain the pressure within the housing and a thickness of greater than 0.400 inches can cause bubbles in the walls that can result in failure.

This figure shows the chamber 21 filled with the media 70 such as chemical retardant ABC, BC, Purple K, flour, pepper, water, fertilizer, insecticide etc. Various types of media can be placed within the chamber. The upper portion of the chamber or reservoir includes an enlarged opening 28 where it joins with the top 30 housing or head. The enlarged opening 70 is greater than 50% of the diameter of the cylindrical chamber or reservoir, but could be up to and including the same diameter with a threading mechanism located on the exterior lip of the cylinder at one or both ends of the cylinder. Threading or other fastening means is used to secure the top 30 and or bottom onto the reservoir or cylinder.

The fastening means can be with internal or external threading on the cylinder and mating end closures or by methods of fastening such as but not limited to bayonet, pins, welding or adhesives. It is also contemplated that the cylinder be fabricated from tubular stock where both the top and the bottom is identical and the ends are attached to the tube when the media delivery system is assembled. The bottom of the chamber or reservoir 20 has a port, hole or opening 102 to allow access to the fluffing knob 100. In the preferred embodiment the top opening is between 75% and 90% of the diameter of the chamber or reservoir. The larger opening allows the contents of the chamber or reservoir to be filled, emptied, inspected, and serviced more easily. The top is screwed onto the chamber, but it could also be attached with a bayonet or latching mechanism. The top 30 of the media delivery system provides the propellant and the connections to emit the media 70.

The head (delivery system) has an emission port and an entry port plus a pick-up tube. It has a safety guard 64 over the charging pin and a lever 60 to fire the powder through the emission port. The powering cartridge 50 is easily installed in the handle 40 attached to the head of the device. The powder cartridge has a fluffier tube with an opening to accept the pick-up tube within the head. Current fire extinguishers must be torn down every six years to fluff the powder, check for caking and to check the condition of the chemical. This media delivery system does not have to be broken down; the powder or media can be fluffed each month, once a year or the chemical cartridge can simple be replaced. The current fire extinguishers have to be subjected to a hydro test every five years for fleet vehicles and every twelve years for the standard extinguishers.

A gas filled pressurized canister 50 is located within the handle 40 of the media delivery system. A port having a first end located on the exterior of said plastic cylindrical chamber where the first end connects to a replaceable pressure filled cylinder and a second end that extends to an interior of the plastic cylindrical chamber or reservoir. It can be seen from this figure that the pressurized canister exists substantially within the handle. The handle provides some protection to the canister for accidental damage. A small portion of the pressurized canister extends beyond the end of the handle to allow access to the pressurized canister or cartridge so it can be installed, removed or serviced without the need to disassemble other parts of the media delivery system.

The pressurized canister is threaded into a fitting 52 within the handle of the media delivery system. The fitting can be of a variety of types that allows engagement of the canister to the media delivery system allowing the gas to be exhausted from the canister into the body of the media delivery system. A trigger 60 or other activation mechanism controls a valve 62 to regulate the flow of the gas from the canister through tube 54 and into the chamber or reservoir. The end of the inlet tube 54 blows gas into the cylinder such that it creates a swirl of the media. Various safety pins, locks, tabs or other devices can be incorporated to reduce or prevent the possibility of accidental activation of the trigger.

When the replaceable pressure filled cylinder is vented within a closed plastic cylindrical chamber the closed plastic cylindrical chamber is pressurized to between 150 psi with the expelling valve closed and 15 when the expelling valve is opened.

The replaceable pressure filled cylinder has an internal volume of between 30 to 100 ml. The replaceable pressure filled cylinder is filled with between 25 and 50 grams of air or gas under pressure of at least 600 psi at 70 degrees Fahrenheit for a five pound extinguisher. The plastic cylindrical chamber for a five pound extinguisher would have an internal volume of between 150 and 250 cubic inches but this ratio can be larger or smaller depending upon the rating capacity of the extinguisher such as a 10 pound extinguisher of an extinguisher that is smaller than five pound rating. The provided ratios are described for a five pound rated extinguisher but similar ratios should be anticipated for larger and smaller sized extinguishers. The internal volume of the five pound extinguisher body includes between 10 to 40 cubic inches 31 for delivery of the pressure filled cylinder to expel the fire suppressing media. The internal volume for a five pound extinguisher includes between 125 to 200 cubic inches 32 of fire suppressing media. The plastic cylindrical chamber is further thermal treated at a temperature of between 100 to 150 degrees Centigrade for between 15 minutes and 2 hours.

The pressure filled cylinder is connected to the top housing with at least one bayonet, interlocking tabs, ball detents, and a hasp. The replaceable rupture pin that ruptures the replaceable pressure filled cylinder is hollow to allow the gas to vent into the body of the chamber or reservoir. The rupture pin 190 is connected to the top housing with at least one bayonet, interlocking tabs, ball detents, and a hasp. The replaceable rupture pin 190 and the replaceable pressure filled cylinder 50 are replaceable as a single unit. The pressure filled cylinder is filed with a gas comprising at least one of oxygen, CO₂, Argon, Helium, and Nitrogen.

In this figure the chamber is shown to provide a view of the fluffing mechanism(s) 120. The fluffing mechanism conditions the media to provide anti-bridging of the media within the chamber to agitate, fluff, turn, disturb, stir, ruffle, and or alters the condition of the media to allow the media to maintain a powder consistency. This allows the media to remain in a liquefied state so it is easier to spray the media. The conditioning of the media can be performed using a variety of methods and in the preferred embodiment the conditioning is performed with an appendage 110 that can be articulated from the exterior 100 of the chamber. The appendage is a shaft that extends the length of the chamber and has a number of flaps 120 attached to the appendage. While flaps are shown and used in the preferred embodiment a variety of other appendages are contemplated that can condition the media that include but are not limited to rods, paddles, arms, disks, cable, chains or combination thereof. It is also contemplated that the appendage can be a simple hook or chain that conditions the media.

The fluffer is formed from two halves of material that is joined to create the fluffing shaft. It is contemplated that the fluffing can be accomplished by blowing gas into the chamber or reservoir through a hole 54 and through the fluffing shaft to fluff the media within the chamber where the gas blows through the shaft and out fluffing holes 104. As previously described the appendage terminates 100 at the bottom of the chamber or reservoir where it can be articulated, but the appendage could terminate at the top or sides of the chamber. The termination at the bottom of the chamber 100 to allow articulation that requires either a key to attach to the appendage, or may terminate with manual knob, handle, wheel or other extension. A manually rotatable handle is shown for manual fluffing of the media.

The nozzle 90 can be turned to direct the spray of media as desired. A valve handle 80 is rotated up to allow the media to be expelled and rotated down to block the flow of media from falling out of the media delivery system when the tank is tipped. In operation when the trigger 60 is depressed the valve 62 is opened and gas from the canister 50 is expelled from the tube 54 into the chamber 20. The chamber becomes pressurized and media 70 is pushed into hole 122 in the bottom of the chamber where it is further pushed up through the central shaft and through the head 92 and out the nozzle 90 where it is dispensed out the opening. The nozzle is shown in a fixed direction but in another contemplated embodiment the nozzle is flexible to allow a user to hold the media delivery system and direct the media out of the nozzle to a fire. While a nozzle is shown in the preferred embodiment other dispensing orifices can be used such as valves, tubing, spray nozzles or similar are contemplated. It is contemplated that an over pressure relief valve can be incorporated within the fire extinguisher to vent any excessive pressure from within the cylinder that could cause the fire extinguisher to burst due to over pressurization of the chamber.

FIG. 20 shows a re-filling operation that allows a spent unit to be re-filled or re-charged. The top 30 of the chamber or reservoir is removed 230 from a used body 29. Any remaining media is discarded. The mixing of old and new media as well as the mixing of media from different manufacturers, different type or usages can causes contamination and makes the media less effective. The top of a refill canister 200 of appropriately rated material or media is removed 240 and the new media is installed 210 onto the top 30 of the spend unit 30. The spent gas cartridge 59 is removed 58 and a new gas cartridge 50 is inserted 51 into the handle of the head. In one contemplated use of the media delivery system, a fireman the media delivery system is configured as a fire extinguisher and a fireman can carry the fire extinguisher with a power refill cartridges 200 and pressurized canisters 50. Once the extinguisher has been used the fireman can re-fill the canister at the fire. The fireman can also carry an empty fire extinguisher with a variety of fire extinguishing media, and can fill the fire extinguisher at the site of the fire once they determine the most appropriate material to use on the fire.

One contemplated fill or refill mechanism is shown as where media or material is contained within the cartridge 200. In this contemplated embodiment the cartridge slides into the cylinder body 20. The media cartridge 200 is configured with wing, arm, flap or tabs that are articulated from the exterior of the replacement cartridge to keep spare cartridges sufficiently fluffed and ready for use. The media cartridges and or pressurized cartridges are recyclable for future re-use.

Thus, specific embodiments of an improved media delivery system using an external pressure cartridge has been disclosed. It should be apparent, however, to those skilled in the art that many more modifications besides those described are possible without departing from the inventive concepts herein. The inventive subject matter, therefore, is not to be restricted except in the spirit of the appended claims.

1. A portable media delivery system comprising:
a plastic chamber having a wall thickness of between 0.080 and 0.400 inches thick containing media within an interior of said plastic chamber;
a port having a first end located on the exterior of said plastic chamber where said first end connects to a replaceable pressure filled cylinder and a second end that extends to an interior of said plastic chamber, and
whereby when said pressure filled cylinder is ruptured, contents of said pressure filed cylinder vents into said port and into said interior of said plastic chamber to expel said media out of an operable exit port of said plastic chamber.

2. The portable media delivery system according to claim 1 in which said plastic chamber is molded plastic.

3. The portable media delivery system according to claim 1 in which said operable exit port can be closed and opened.

4. The portable media delivery system according to claim 1 wherein when said replaceable pressure filled cylinder is vented within a closed said plastic chamber said closed plastic chamber is pressurized to between 15 and 150 psi.

5. The portable media delivery system according to claim 1 wherein said replaceable pressure filled cylinder has an internal volume of between 30 to 100 ml.

6. The portable media delivery system according to claim 5 wherein said replaceable pressure filled cylinder is filled with between 10 and 100 grams of air or gas under pressure of at least 600 psi at 70 degrees Fahrenheit.

7. The portable media delivery system according to claim 1 wherein said plastic chamber has an internal volume of between 50 and 500 cubic inches.

8. The portable media delivery system according to claim 7 wherein said internal volume includes between 5 to 100 cubic inches for delivery of said pressure filled cylinder to expel said media.

9. The portable media delivery system according to claim 7 wherein said internal volume includes between 50 to 500 cubic inches of media.

10. The portable media delivery system according to claim 1 wherein said plastic chamber is further thermal treated at a temperature of between 50 to 300 degrees Centigrade.

11. The portable media delivery system according to claim 1 wherein said plastic chamber is further thermal treated for between 15 minutes and 2 hours.

12. The portable media delivery system according to claim 1 wherein said replaceable pressure filled cylinder is at least partially located within a handle of said portable fire extinguisher.

13. The portable media delivery system according to claim 1 further having a bottom housing and a top housing that are connected with a quick disconnect.

14. The portable media delivery system according to claim 13 wherein pressure filled cylinder is connected to said top housing with at least one bayonet, interlocking tabs, ears ball detents, and a hasp.

15. The portable fire extinguisher according to claim 1 that further includes a replaceable rupture pin that ruptures said claim 1 replaceable pressure filled cylinder

16. The portable fire extinguisher according to claim 15 wherein said replaceable rupture pin has at least one vent.

17. The portable fire extinguisher according to claim 15 wherein said replaceable rupture pin is connected to said top housing with at least one bayonet, interlocking tabs, ears, ball detents, and a hasp.

18. The portable media delivery system according to claim 15 wherein said replaceable rupture pin and said replaceable pressure filled cylinder are replaceable as a single unit.

19. The portable media delivery system according to claim 1 wherein said plastic chamber is at least semi-transparent.

20. The portable media delivery system according to claim 1 wherein said replaceable pressure filled cylinder is filed with a gas comprising at least one of oxygen, CO₂, Argon, Helium, and Nitrogen.
